(19) United States
(12) Patent Application Publication
(10) Pub. No.: US 2026/0058169 A1
(43) Pub. Date: Feb. 26, 2026

(54) SEPARATOR FOR FUEL CELL

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 19/306,099

(22) Filed: Aug. 21, 2025

(30) Foreign Application Priority Data
Aug. 26, 2024 (JP) 2024-144194

(51) Int. Cl. H01M 8/0254; H01M 8/0258

(52) U.S. Cl. CPC H01M 8/0254; H01M 8/0258

(57) ABSTRACT

A separator for a fuel cell includes a plate-shaped body including multiple ribs extending in parallel. The ribs protrude from the body to come into contact with a gas diffusion layer of a membrane electrode gas diffusion layer assembly. Spaces between the ribs and between the body and the gas diffusion layer form passages through which gas is supplied to and discharged from the membrane electrode gas diffusion layer assembly. The ribs include dividing portions that divide the passages extending in parallel. Each dividing portion divides the corresponding passage into sections on upstream and downstream sides in a gas flow direction. The positions of the dividing portions in the gas flow direction of the passages are set to be different between adjacent ones of the passages in a direction in which the ribs are arranged in parallel.

### CROSS-REFERENCE TO RELATED APPLICATIONS

This application is based upon and claims the benefit of priority from Japanese Patent Application No. 2024-144194, filed on Aug. 26, 2024, the entire contents of which are incorporated herein by reference.

### BACKGROUND

### 1. Field

The present disclosure relates to a separator for a fuel cell.

### 2. Description of Related Art

A cell stack of a fuel cell is formed by stacking single cells in the thickness direction. Each single cell is formed by sandwiching a membrane electrode gas diffusion layer assembly with plate-shaped separators from the opposite sides in the thickness direction. The separator for a fuel cell disclosed in JP2010-3531A includes a body having ribs that extend in parallel. The ribs protrude from the body to come into contact with each gas diffusion layer of the membrane electrode gas diffusion layer assembly. Spaces defined by the ribs and the gas diffusion layer form passages through which gas is supplied to and discharged from the membrane electrode gas diffusion layer assembly.

One of the opposite sides of the membrane electrode gas diffusion layer assembly in the thickness direction is an anode side, and the other side is a cathode side. Fuel gas (e.g., hydrogen) flows in the passages between the separator and the gas diffusion layer on the anode side. Oxidation gas (e.g., air) flows in the passages between the separator and the gas diffusion layer on the cathode side. Power is generated in the single cell based on the reaction between the fuel gas and the oxidation gas at the membrane electrode gas diffusion layer assembly. The gas diffusion layers of the membrane electrode gas diffusion layer assembly serve to uniformly supply gas to the membrane electrode gas diffusion layer assembly by diffusing the gas delivered from the passages.

In the single cell described above, since the gas within each passage flows along the ribs, the gas does not readily enter the gas diffusion layer of the membrane electrode gas diffusion layer assembly from the passage. As a result, when gas is supplied to the membrane electrode gas diffusion layer assembly from the passages, diffusion of the gas in each gas diffusion layer tends to be reduced, which may lead to a reduction in the power generation efficiency of the single cell.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a separator for a fuel cell includes a plate-shaped body including multiple ribs extending in parallel. The body is configured to be disposed on one of opposite sides of a membrane electrode gas diffusion layer assembly in a thickness direction. The ribs protrude from the body to come into contact with a gas diffusion layer of the membrane electrode gas diffusion layer assembly. Spaces between the ribs and between the body and the gas diffusion layer form passages through which gas is supplied to and discharged from the membrane electrode gas diffusion layer assembly. The ribs include dividing portions that divide the passages extending in parallel. Each dividing portion divides the corresponding passage into sections on upstream and downstream sides in a gas flow direction. Positions of the dividing portions in the gas flow direction of the passages are set to be different between adjacent ones of the passages in a direction in which the ribs are arranged in parallel.

Other features and aspects will be apparent from the following detailed description, the drawings, and the claims.

### BRIEF DESCRIPTION OF THE DRAWINGS

FIG. 1 is an exploded perspective view showing a single cell of a fuel cell.

FIG. 2 is a cross-sectional view of a cell stack in which single cells having the structure shown in FIG. 1 are stacked.

FIG. 3 is a schematic diagram showing ribs and passages of a separator in the single cell shown in FIG. 1.

FIG. 4 is a schematic diagram showing contact regions between adjacent single cells when single cells each having the structure shown in FIG. 1 are stacked.

FIG. 5 is a schematic diagram showing ribs and passages of a separator according to another example.

FIG. 6 is a schematic diagram showing ribs and passages of a separator according to another example.

FIG. 7 is a schematic diagram showing ribs and passages of a separator according to another example.

FIG. 8 is a schematic diagram showing ribs and passages of a separator according to another example.

FIG. 9 is a schematic diagram showing ribs and passages of a separator according to another example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art.

Sequences of operations are exemplary, and may be changed as apparent to one of ordinary skill in the art, with the exception of operations necessarily occurring in a certain order.

Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

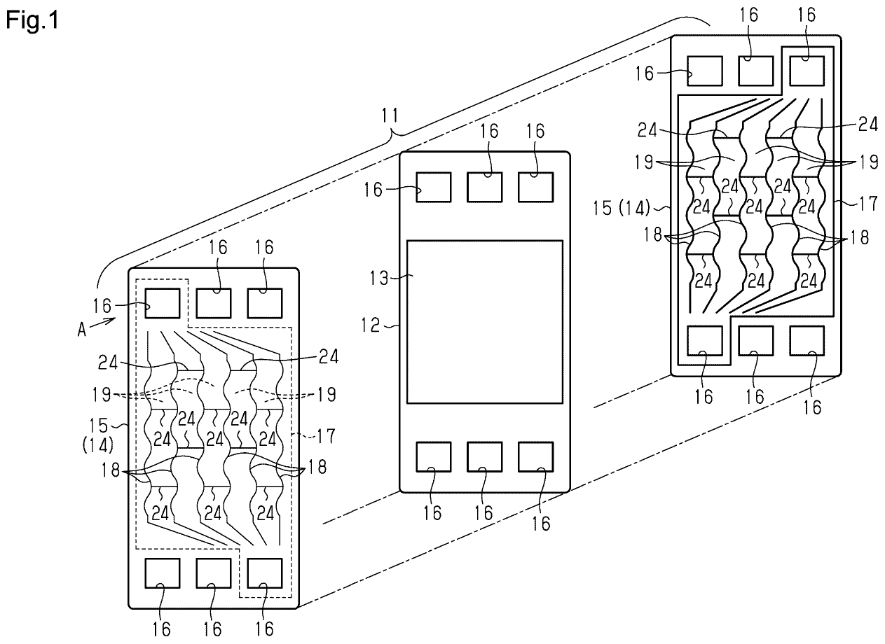

A separator 14 for a fuel cell according to an embodiment will now be described with reference to FIGS. 1 to 4.

FIG. 1 shows a single cell 11 used to form a cell stack of a fuel cell. The single cell 11 includes a plastic plate 12, a membrane electrode gas diffusion layer assembly 13, and separators 14. The plastic plate 12 is formed to have the shape of a rectangular frame. The outer edge of the membrane electrode gas diffusion layer assembly 13 is joined to the plastic plate 12. The plastic plate 12 and the membrane electrode gas diffusion layer assembly 13 are sandwiched by the separators 14, which are respectively arranged on the opposite sides in the thickness direction.

The cell stack of the fuel cell is formed by stacking multiple single cells 11 in the thickness direction. The plastic plates 12 and the separators 14 of the cells 11 each have holes 16. Three of the holes 16 are located at one end of the single cell 11 in the long-side direction, and the other three are located at the other end of the single cell 11 in the long-side direction. One of the holes 16 at one end in the long-side direction of the single cell 11 is paired with one of the holes 16 at the other end. Each pair of the holes 16 is used to allow a fluid (e.g. fuel gas such as hydrogen, oxidation gas such as air, or coolant) to flow therethrough.

The separators 14 each include a body 15 that is made of metal (e.g., stainless steel, titanium, or aluminum) and formed to have the shape of a rectangular plate. The body 15 includes ribs 19 that are parallel to each other and extend in the long-side direction. A seal member 17 is arranged between the body 15 of each separator 14 and the plastic plate 12. The seal member 17 can be provided on both the front and back surfaces of the plastic plate 12 in the thickness direction.

The seal member 17, arranged on the front surface of the plastic plate 12, surrounds a pair of the holes 16, the pair being positioned on one of the two diagonal lines of the plastic plate 12 and the corresponding separator 14. The seal member 17 also surrounds the anode side of the membrane electrode gas diffusion layer assembly 13. The seal member 17 also surrounds the ribs 19 in the separator 14 on the anode side. Further, a passage 18 through which fuel gas flows is defined between adjacent ones of the ribs 19 in the separator 14. Fuel gas can be supplied to the passages 18 through the pair of holes 16.

Also, the seal member 17 arranged on the back side of the plastic plate 12 surrounds a pair of the holes 16 positioned on the other one of the two diagonal lines of the plastic plate 12 and the corresponding separator 14. The seal member 17 also surrounds the cathode side of the membrane electrode gas diffusion layer assembly 13. The seal member 17 also surrounds the ribs 19 in the separator 14 on the cathode side. Further, a passage 18 through which oxidation gas flows is defined between adjacent ones of the ribs 19 in the separator 14. Oxidation gas can be supplied to the passages 18 through the pair of holes 16.

In the fuel cell stack of the single cells 11, the fuel gas flows along the anode side of the membrane electrode gas diffusion layer assembly 13, and the oxidation gas flows along the cathode side of the membrane electrode gas diffusion layer assembly 13. When the fuel gas and the oxidation gas respectively flow along the anode side and the cathode side of the membrane electrode gas diffusion layer assembly 13, power is generated based on the reaction between the fuel gas and the oxidation gas in the membrane electrode gas diffusion layer assembly 13.

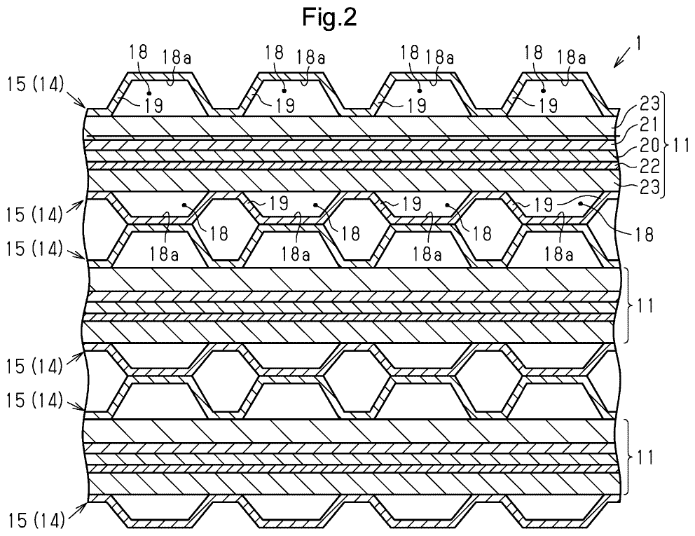

As shown in FIG. 2, the membrane electrode gas diffusion layer assembly 13 of each single cell 11 includes an electrolyte layer 20, a cathode electrode layer 21, an anode electrode layer 22, and a gas diffusion layer 23. The electrolyte layer 20 is formed by, for example, a solid polymer membrane. The cathode electrode layer 21 is joined to one side of the electrolyte layer 20 in the thickness direction (the upper side in FIG. 1). The anode electrode layer 22 is joined to the other side in the thickness direction of the electrolyte layer 20 (the lower side in FIG. 1). The surface of the cathode electrode layer 21 opposite to the electrolyte layer 20 is covered by the gas diffusion layer 23. The surface of the anode electrode layer 22 opposite to the electrolyte layer 20 is covered by another gas diffusion layer 23, which is different from the aforementioned gas diffusion layer 23.

Two separators 14 are respectively located on the cathode side and the anode side of the membrane electrode gas diffusion layer assembly 13. The ribs 19 in each separator 14 are formed by bending the body 15 of the separator 14 so as to protrude in the thickness direction of the separator 14. The separator 14 on the cathode side of the membrane electrode gas diffusion layer assembly 13 and the separator 14 on the anode side of the membrane electrode gas diffusion layer assembly 13 have the same shape. However, the separator 14 on the cathode side is disposed such that a front side and a back side, which are opposite surfaces in the thickness direction, are flipped with respect to the separator 14 on the anode side.

The multiple ribs 19 of the separator 14 on the cathode side protrude toward the gas diffusion layer 23 on the cathode side. These ribs 19 are in contact with the gas diffusion layer 23 on the cathode side. The spaces between the ribs 19 of the separator 14 and between the body 15 of the separator 14, and the gas diffusion layer 23 form passages 18 through which oxidation gas flows. The ribs 19 of the separator 14 on the anode side protrude toward the gas diffusion layer 23. These ribs 19 are in contact with the gas diffusion layer 23 on the anode side. The spaces between the ribs 19 of the separator 14 and between the body 15 of the separator 14 and the gas diffusion layer 23 form passages 18 through which fuel gas flows.

### Details of the Ribs 19 and the Passages 18 in the Separator 14

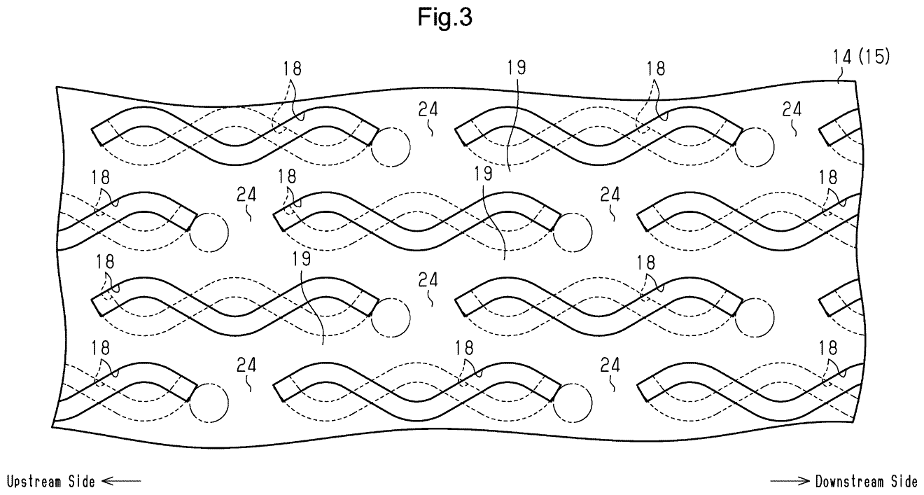

FIG. 3 schematically shows the ribs 19 and the passages 18 of each separator 14. As can be seen from FIG. 3, the ribs 19 include dividing portions 24 that divide the passages 18 extending in parallel. Specifically, each dividing portion 24 divides the corresponding passage 18 into sections on the upstream and downstream sides in the gas flow direction. In FIG. 3, the left side is the upstream side of the gas flow, and the right side is the downstream side of the gas flow.

The positions of the dividing portions 24 in the gas flow direction of the passages 18 (i.e., the left-right direction in FIG. 3) are set to be different between adjacent ones of the passages 18 in the direction in which the ribs 19 are arranged in parallel (i.e., the up-down direction in FIG. 3). Specifically, the dividing portions 24 are formed at equal intervals in the direction in which the ribs 19 extend. Each of the dividing portions 24 corresponding to a given passage 18 is located at a middle position between two of the dividing portions 24 corresponding to a passage 18 that is adjacent to the given passage 18 in the arrangement direction of the parallel ribs 19.

The ribs 19 and the dividing portions 24 in the body 15 of each separator 14 are formed as follows. Specifically, two separators 14 are disposed on the opposite sides of each membrane electrode gas diffusion layer assembly 13 in the thickness direction, and each passage 18 is divided into sections by the corresponding dividing portions 24 such that the downstream end of each divided section of each passage 18 in one of the separators 14 corresponds to the downstream end of a divided section of the corresponding passage 18 in the other separator 14. In FIG. 3, the sections of the passages 18 divided by the dividing portions 24 in one separator 14 are indicated by the solid lines, while the sections of the passages 18 divided by the dividing portions 24 in the other separator 14 are indicated by the broken lines.

The ribs 19 of the body 15 in a separator 14 are formed such that the extending direction is different between when the separator 14 is on one side in the thickness direction of the membrane electrode gas diffusion layer assembly 13 and when the separator 14 is on the other side.

Each rib 19 is formed in a wavy shape having a fluctuation width in a direction intersecting with the direction in which the rib 19 extends (i.e. the up-down direction in FIG. 3). Since the ribs 19 are formed in wavy shapes, the extending direction is different between when the separator 14 is on one side in the thickness direction of the membrane electrode gas diffusion layer assembly 13 and when the separator 14 is on the other side.

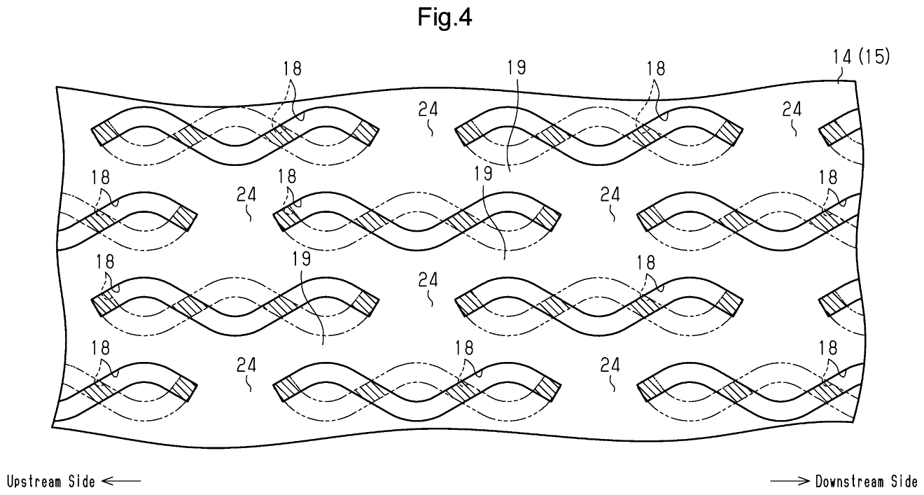

As a result, when the cell stack of the fuel cells is pressed in the stacking direction of the single cells 11, the portions of the bodies 15 of the separators 14 corresponding to the bottoms 18a of the passages 18 come into contact with each other in the adjacent single cells 11. These contact portions are indicated by the hatched regions in FIG. 4.

### Operation and Advantages of the Separator 14 for a Fuel Cell in the Present Embodiment

(1) Gas supplied to and discharged from the membrane electrode gas diffusion layer assembly 13 flows through the passages 18. Each passage 18 is divided by the dividing portions 24 of the corresponding ribs 19 into multiple sections on the upstream and downstream sides in the flow direction of the gas in the passages 18. Therefore, when the gas flowing downstream in each passage 18 reaches the part divided by the dividing portion 24, i.e., the downstream end of each divided section, the gas enters the gas diffusion layer 23 from the downstream end. Furthermore, the gas that has entered the gas diffusion layer 23 spreads radially from the downstream ends of the sections of the passages 18 as indicated the circles of long-dash double-short-dash lines in FIG. 3, and then enters the adjacent sections of the passages 18. The flows of the gas in the gas diffusion layer 23 promote diffusion of the gas in the gas diffusion layer 23. As a result, when gas is supplied to the membrane electrode gas diffusion layer assembly 13 from the passages 18, diffusion of the gas in the gas diffusion layer 23 is not hindered. Accordingly, this configuration helps prevent a decline in the power generation efficiency of the single cell 11 that could otherwise result from insufficient gas diffusion in the gas diffusion layer 23.

If the dividing portions 24 were aligned in the gas flow direction between adjacent ones of the passages 18, flows of the gas entering the gas diffusion layer 23 from the downstream ends of the sections of the adjacent passages 18 could interfere with each other when the flows spread radially from the downstream ends. Such interference of the gas could hinder gas diffusion in the gas diffusion layer 23. However, the positions of the dividing portions 24 in the gas flow direction of the passages 18 are set to be different between adjacent ones of the passages 18. Therefore, the flows of gas entering the gas diffusion layer 23 from the downstream ends of sections of adjacent passages 18 are prevented from interfering with each other when the flows spread radially from the downstream ends. Consequently, the reduction in gas diffusion within the gas diffusion layer 23 due to such gas flow interference is prevented.

(2) The separators 14 (the bodies 15) are disposed on the opposite sides of the membrane electrode gas diffusion layer assembly 13 in the thickness direction. The separators 14 are located on the opposite sides in the thickness direction of the membrane electrode gas diffusion layer assembly 13 such that the front side and the back side of one of the separators 14 are inverted with respect to the other separator 14. The ribs 19 and the dividing portions 24 in the bodies 15 of the separators 14 are formed such that the downstream end of each section of the passages 18 divided by the dividing portions 24 in the body 15 of one separator 14 is positioned to correspond to the downstream end of one section of the passages 18 divided by the dividing portions 24 in the body 15 of another separator 14. Specifically, the downstream ends of the sections of the passages 18 in one separator 14 are positioned as indicated by the solid lines in FIG. 3, and the downstream ends of the section of the passage 18 in the other separator 14 are positioned as indicated by the broken lines in FIG. 3. Therefore, the gas that has entered the gas diffusion layer 23 from the downstream ends of the sections of the passages 18 corresponding to one of the separators 14 and the gas that has entered the gas diffusion layer 23 from the downstream ends of the sections of the passages 18 corresponding to the other separator 14 are located at aligned positions on the opposite sides of the membrane electrode gas diffusion layer assembly 13. This improves the power generation efficiency when power is generated based on the reaction between the fuel gas and the oxidation gas in the membrane electrode gas diffusion layer assembly 13.

(3) The ribs 19 of the body 15 of each separator 14 are formed so as to extend in different directions depending on whether the separator 14 is located on one side or the other side in the thickness direction of the membrane electrode gas diffusion layer assembly 13. As a result, the portions corresponding to the bottoms 18a of the passages 18 in the body 15 of each of the separators 14 also extend corresponding to the ribs 19 of the body 15. When the cell stack of the fuel cells is pressed in the stacking direction of the single cells 11, the portions of the bodies 15 of the separators 14 corresponding to the bottoms 18a of the passages 18 come into contact with each other in the adjacent single cells 11. In other words, these contacting portions do not engage in an alternating or interlocked manner. Therefore, this configuration prevents a decrease in the surface pressure exerted from the body 15 of the separator 14 onto the membrane electrode gas diffusion layer assembly 13 during compression of the fuel cell stack of the fuel cell in the stacking direction of the single cells 11, thereby suppressing degradation in power generation efficiency.

(4) In the body 15 of each separator 14, each rib 19 is formed in a wavy shape having a fluctuation width in a direction intersecting with the direction in which the rib 19 extends. Thus, the ribs 19 of the body 15 of each separator 14 extend in different directions depending on whether the separator 14 is located on one side or the other side of the membrane electrode gas diffusion layer assembly 13 in the thickness direction.

(5) The dividing portions 24 are formed at equal intervals in the direction in which the ribs 19 extend. Each of the dividing portions 24 corresponding to a given passage 18 is located at a middle position between two of the dividing portions 24 corresponding to a passage 18 that is adjacent to the given passage 18 in the arrangement direction of the parallel ribs 19. Therefore, the flows of gas entering the gas diffusion layer 23 from the downstream ends of sections of adjacent passages 18 are prevented from interfering with each other when the flows spread radially from the downstream ends.

The above-described embodiment may be modified as follows. The above-described embodiment and the following modifications can be combined as long as the combined modifications remain technically consistent with each other.

In the above-described embodiment, each of the dividing portions 24 corresponding to a given passages 18 is located at a middle position between two of the dividing portions 24 corresponding to another passage 18 adjacent to the given passages 18 in the arrangement direction of the parallel ribs 19. However, the present disclosure is not limited to this.

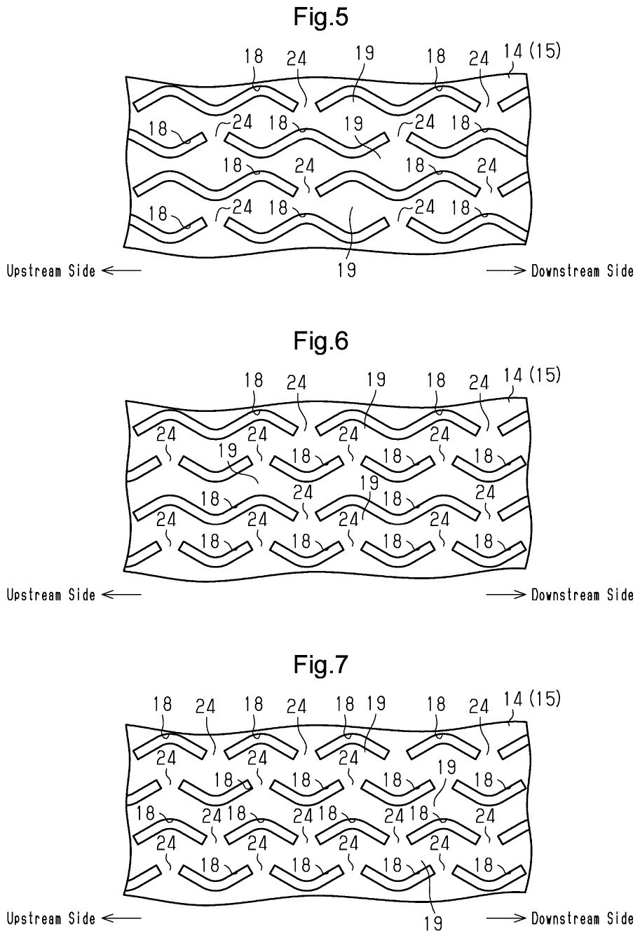

The ribs 19 and the sections of the passages 18 do not necessarily need to have curved shapes as shown in FIG. 3, and may be formed in curved shapes as shown in FIGS. 5, 6, or 7, for example.

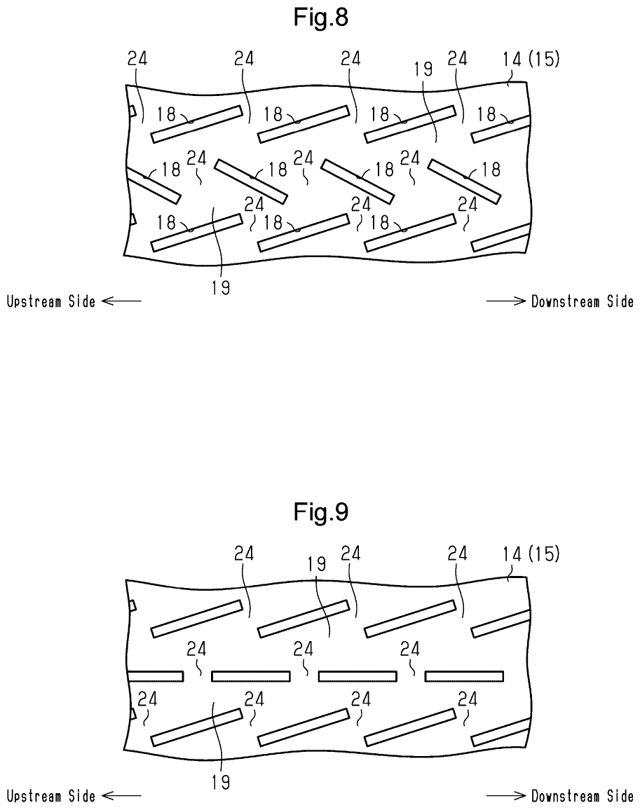

Some of the ribs 19 and sections of the passages 18 may be formed such that the sections of the passages 18 are straight, for example as shown in FIGS. 8 and 9.

The ribs 19 do not necessarily need to be formed to extend in different directions depending on whether the separator 14 is located on one side or the other side in the thickness direction of the membrane electrode gas diffusion layer assembly 13.

The downstream end of each section of the passages 18, which are divided by the dividing portions 24, in one of the separators 14 on the opposite sides in the thickness direction of the membrane electrode gas diffusion layer assembly 13 does not necessarily need to correspond to the downstream end of a section of the passages 18 in the other separator 14.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A separator for a fuel cell, comprising a plate-shaped body including multiple ribs extending in parallel, wherein
the body is configured to be disposed on one of opposite sides of a membrane electrode gas diffusion layer assembly in a thickness direction,
the ribs protrude from the body to come into contact with a gas diffusion layer of the membrane electrode gas diffusion layer assembly,
spaces between the ribs and between the body and the gas diffusion layer form passages through which gas is supplied to and discharged from the membrane electrode gas diffusion layer assembly,
the ribs include dividing portions that divide the passages extending in parallel, each dividing portion dividing the corresponding passage into sections on upstream and downstream sides in a gas flow direction, and
positions of the dividing portions in the gas flow direction of the passages are set to be different between adjacent ones of the passages in a direction in which the ribs are arranged in parallel.

2. The separator for the fuel cell according to claim 1, wherein
the separator is used in a pair,
the separators are configured to be arranged such that, when arranged on opposite sides of the membrane electrode gas diffusion layer assembly in the thickness direction, a front side and a back side of the body of one of the separators are flipped with respect to the body of the other separator, and
the ribs and the dividing portions in the bodies are formed such that a downstream end of each section of the passages divided by the dividing portions in the body of one of the separators is positioned to correspond to a downstream end of one section of the passages divided by the dividing portions in the body of the other separator.

3. The separator for the fuel cell according to claim 1, wherein
the separator is used in a pair,
the separators are configured to be arranged such that, when arranged on opposite sides of the membrane electrode gas diffusion layer assembly in the thickness direction, a front side and a back side of the body of one of the separators are flipped with respect to the body of the other separator, and
the ribs of each body are formed so as to extend in different directions depending on whether the body is located on one side or the other side in the thickness direction of the membrane electrode gas diffusion layer assembly.

4. The separator for the fuel cell according to claim 3, wherein each rib is formed in a wavy shape having a fluctuation width in a direction intersecting with a direction in which the rib extends.

5. The separator for the fuel cell according to claim 1, wherein
the dividing portions are formed at equal intervals in a direction in which the ribs extend, and
each of the dividing portions corresponding to a given passage is located at a middle position between two of the dividing portions corresponding to a passage that is adjacent to the given passage in the direction in which the parallel ribs are arranged.
